(19) United States
(12) Patent Application Publication
(10) Pub. No.: US 2005/0089543 A1
(43) Pub. Date: Apr. 28, 2005

(54) Animal scent based repellent and attractant compositions

(76) Inventor: Mark James Weiser, Evans City, PA (US)

Correspondence Address: METZ LEWIS, LLC, 11 STANWIX STREET, 18TH FLOOR, PITTSBURGH, PA, 15222, US

(21) Appl. No.: 10/993,654

(22) Filed: Nov. 19, 2004

Related U.S. Application Data
(62) Division of application No. 09/773,756, filed on Feb. 1, 2001.

(51) Int. Cl. A01N 25/08; A01N 45/00

(52) U.S. Cl. 424/410

(57) ABSTRACT

An animal repellent composition is disclosed that comprises a carrier base and a repellent material. The carrier base and the repellent material are mixed together in a resulting formulation that is used to provide a natural means of deterring unwanted pests and animals from the area in which the composition is used. The composition may also be used as an animal attractant depending on the formulation of the mixed materials. The formulation of the composition can be varied to produce mixtures with different consistencies and properties.

### FIELD AND BACKGROUND OF THE INVENTION

The invention relates to the field of animal control and in particular to animal attractants and repellants. Attractants being those odors associated with animals that tend to attract other animals such as game animals like deer. Repellants being those animal odors that repel animals such as a coyote smell that may repel animals such as rabbits from a garden or similar area.

The invention is particularly directed to scent compositions based upon mixing animal associated products such as urine and glandular secretions with a base carrier composition such as calcium carbonate. Such compositions are then spread in areas e.g. flower beds, golf courses, cemeteries, etc. where it is desired to repel certain animals such as deer, rabbits, mice, moles squirrels, cats, etc.

The finished product may then be spread about the perimeter of areas where it is desired to repel particular animals. Such areas include: gardens, cemeteries, golf courses, nurseries, farms and the like. The composition will give off the scent of a predator animal that is a predator of the animal(s) that is to be repelled from or attracted to. The product will give off the scent for a period of time of several days to several weeks.

Other more specific formulations of the invention include compositions that may be used as animal attractants.

### SUMMARY OF THE INVENTION

An animal repellent composition is described comprising a carrier base chosen from materials such as calcium carbonate, magnesium carbonate as well as many others and a repellent material based upon an odorous animal product associated with a predator animal. Typically, such odorous material would be in the form of urine, feces, and or glandular secretions of animals. For purposes of uniformity we will use the term “animal product” to include all these animal associated compositions that may be collected from animals and mixed with the carrier material in the invention.

The animal repellent material is mixed with the carrier and the resulting formulation may be spread around areas in order to deter animals from approaching. Zeolites may be used to enhance the time release effect of the compositions.

An object of the invention is to provide a natural means of deterring unwanted pests by a composition comprising an animal secretion in association with carrier material.

Another object of the invention is an odor emitting composition based upon natural animal secretions that will emit the odor of a predator animal for a long period of time and so deter animals from entering an area where the composition is used.

Another object of the invention is to provide an animal deterrent composition that is made of all natural materials and will not pose an environmental threat or a threat to humans or animals.

Other objects will be apparent to those skilled in the art once the invention is shown and described.

### DESCRIPTION OF THE PREFERRED EMBODIMENT

The preferred materials for the carrier (or base) composition include: calcium carbonate; magnesium carbonate vermiculite, sawdust, small particles of wood, potting soil, peat moss, topsoil, limestone, small particles of rock; sand, sodium bicarbonate; zeolites, activated charcoal; mulch compounds; crushed seashells, various types of silica, psyllium husks; solid predator glands, polymeric materials, waxes, corn starch, salts, crushed or ground clays, shredded paper, talc, magnesium stearate; natural and synthetic sponge; seeds and grains, ground corncob; gypsum; straw, hay, and mulch.

In the case of straw, hay, seeds, mulch and wood this category of carrier may be generally stated to be a “fibrous plant product.” When such fibrous plant products are used in the invention they must necessarily be ground up if they are to be used with the animal product in a liquid, gel or powder form.

Such carrier materials are useful from the stand point of the invention because they can all function as bedding material for a deer, coyote, etc. In which all the animal products associated with such animal (e.g. urine, saliva, odors, glandular secretions, etc.) can be collected by the bedding material. The bedding material is then formulated with an animal product such as animal urine, animal saliva, etc. to make the final product. Using animal bedding material as the carrier creates an animal attractant and/or repellant that is of better quality than simply pure urine because it contains all of the animal products not just one liquid.

Zeolite material may be used in combination with one of the above carriers. In the case of a zeolite mixture, the product can work well as both an animal attractant and repellent. The preferred zeolite to use in the invention is Clinoptilolite, which is sodium and potassium based zeolite material. Other zeolites are possible without varying from the spirit of the invention.

Other carrier materials may be used without varying from the spirit of the invention.

Polymeric materials may be used as carriers for the invention and their use is likely to produce a “gel” type of product when mixed with the animal product (or “animal scent”). Polymeric materials believed to be most useful in the invention include: polystyrenes, polyacrylates, and polyacrylamides that are both cross linked and non cross linked. Preferred polymeric materials include: sodium salts of cross linked polyacrylic acid; a co-polymer of cross linked potassium polyacrylate and polyacrylamide; granular acrylate polymers including a copolymer of polyacrylate and polyacrylamide. Other polymeric materials may find use in the invention.

The small particles of wood referenced above may be in the form of incense (in a cone or stick form) which comprises essentially compressed wood. In this case, the incense should not be of the commonly available scented type of incense that produces a strong odor when lit. In this particular case, the invention would use an unscented wood particle stick (referred to here as an “incense stick”) that may be dipped into the animal product such as urine, glandular secretions, etc. Then, the material may be dried by air or other method. Note that this type of in “incense stick” is not meant to be burned in order to function as an animal attractant/repellant.

Fumed or fuming silicas are thought the best type of silicas for use in the invention. Alumina used in the invention should be treated with a peroxide, e.g by immersing the alumina in the peroxide, in order to enhance the porosity of the alumina.

The following list of animal product materials are associated with predator animals and they constitute the odorous animal product material in the invention: urine, feces, glandular secretions as well as other unknown constituents, collected from animals, that may be said to give off an odor related to the animal.

Urine is the mostly likely form of the active ingredient in the predator repellent and, in the preferred embodiment, a mixture of animal urine (as well as other constituents) may be mixed with a carrier, for example calcium carbonate. Such urine may be collected from the animals on a year round basis and the urine is then mixed with the carrier.

The preferred secretions would come from animals such as: deer, elk, moose, wolf, fox, coyote, cougar, lion, tiger, cow goat, sheep, etc. The list is by no means exclusive but is a list of the animals, whose secretions are thought to be most useful in working the invention. Most of the formulations may be thought of as being one of two types: animal attractants such as deer, elk and moose scent which are useful to hunters for attracting an animal that they are trying to hunt. Such as using a deer smell to attract a deer.

The other category would be predator animals such as coyote useful as a repellant to deter animals that are preyed upon by coyote, such as rabbits, etc. Such predator smells could also attract animals too, for example a coyote odor may attract another coyote or another carnivorous animal simply on the basis of curiousity or other reasons.

Mixing of the formulation may be done in one of two methods or using both. The first method is to directly mix the animal product such as urine into the carrier material. Such mixing may then be done by hand or by machine. Such method will require the manufacture to choose to add the animal product on an ingredient by ingredient basis. For example he may add urine only to a calcium carbonate carrier or urine and glandular secretions to the carrier, etc.

The second method is a natural method of having the animal impregnate the carrier material by using the carrier material as bedding material for the animal itself. The animals may be kept captive in a farm or nursery or the like and as the animal contacts the material it will urinate on the material, rub up against it, walk, sleep, breed, or otherwise come in contact with the material. Such process might take for example 3-5 days but this time can vary considerably.

The resulting animal impregnated carrier of this method will necessarily include several such animal products, not just one type of ingredient. For example if deer are used, animal products including: interdigital glandular material from the hoof, urine, tarsal material (associated with tarsal glands in the hind legs) caused by urine of the deer dripping down the hind legs; feces, body odor, saliva, other odors depending on the time of year that the deer is bedded.

It is also possible to combine both methods in the same formulation taking for example a carrier such as sand or potting soil that has been used as animal bedding and mixing this product with a pure amount of urine or pure glandular material, etc. One could also then take this mixture and add calcium carbonate or zeolite, etc. to further enhance the carrier. Such method would also include further mixing at the stage where the pure animal product and/or pure carrier is added.

By similar reasoning, a pure animal product like pure coyote urine or a pure deer glandular material may be more expensive to collect or purchase and used as the sole active ingredient in such composition. However, by using a mixture of the pure urine or pure glandular component in combination with several animal products impregnated naturally onto a carrier by the animal itself a superior blend of product can be made. I.e. the active ingredient is both a mixture of animal product produced by natural bedding methods and enhanced with a pure animal product e.g. pure urine.

Varying the proportion of base or carrier material vis a vis the animal product (this also may be referred to as “animal scent” for purposes of the invention) will produce compositions that can be both powder and liquid forms of the product. In addition, the proper mix of polymeric materials and animal product will produce a gel type of product that is also found useful in this field. Both powder and liquid formulations may draw from the same list of carrier ingredients previously recited, one does not need to use a liquid carrier material, the proper mix of dry carrier and the liquid form animal product will produce the liquid form of the composition.

In the case of those formulations of the invention where the final product is in a dry form (most likely a powder form), it is found that the ratio of carrier to animal product can vary from 99.7% carrier to 0.3% animal product at the high end, and as low as 70% carrier to 30% animal product on the low end. The preferred ratio for the dry form is approximately 94% carrier to 6% liquid animal product.

Note that the carrier material may also include a blend of two or more carrier materials from the aforementioned list as well a single carrier constituent. The “animal product” being urine, glandular, secretions, etc.

For example one possible dry powder form composition would be: a mixture of both 40% calcium carbonate; 40% vermiculite and then combined with 20% predator product (all proportions based on weight).

Another example of such composition: 30% calcium carbonate; 20% vermiculite 20% topsoil, 20% sawdust and 10% predator liquid (all proportions based on weight).

Liquid formulations of the invention will use a higher proportion of the animal product in them. In this case/ the ratio of carrier to animal product can vary from 69% carrier and 31% animal product at the high end, and as little as 0.001% carrier to 99.999% animal product on the other end. The preferred ratio for the liquid form of the composition is approximately 15% carrier to 85% liquid animal product.

In the polymer based gel forms of the product it is found that the proportion can range from 1% polymer carrier and 99% liquid animal urine, up to 72% polymer carrier to 28% animal product. The preferred ratio for the gel formulation is 17% polymer to 83% animal product.

In the cases where zeolite is used as one of the carriers, this is thought to result in an improved product that will have a longer lasting and longer odor emitting repellent and/or attractant when it is used outdoor. Without being bound by a theory of why this is so, it is thought that the zeolite structure changes conformation in accordance with certain changes in the atmosphere, notably the temperature.

In this case, changes in the outdoor temperature would result in changes in zeolite conformation and that will in turn release the odor particles over a long period of time. Such a process may be described as a more or less timed release of the predator odor and/or animal odor.

The preferred ratio of a zeolite mixture as the carrier would be in the ratio of 30% to 60% zeolite in relation to the other carrier. So e.g. 30% zeolite to 70% calcium carbonate would be a preferred mix for the carrier. This carrier in turn would be mixed as a 70%-95% carrier to 5-30% predator animal product.

Even without zeolites in the composition, the compositions will have a certain amount of time release character. Most such compositions should at least be able to repel animals for 3 or 4 days. Such time period may be cut short by rainfall and other inclement weather.

A process for using the product may also be marketed to consumers without having to mix the animal product at the wholesale end of the distribution chain. In this case, the manufacturer would sell the dry carrier ingredients as mix for consumers to mix their own animal products into the mix at home. Such a product may include any or all of the carrier materials listed here (including mixtures of such carrier ingredients) and would come with instructions on how the consumer is to mix his own animal repellant or attractant product formulations at home.

It is found that coyote animal product (including mainly coyote urine but also might include glandular secretions, odors, feces, etc.) is effective at repelling: deer/racoon and elk. Mixtures using fox urine is effective in repelling: chipmunks, groundhogs, mice, moles, possum, rabbit, rats, shrews, skunks, squirrels, voles and woodchucks. Such animal repellant products might also have the side effect of attracting predator type animals.

Varying the mix of carriers and varying the proportions of carrier materials to animal product will result in mixtures with different consistencies, and differences in other properties associated with the mixture. Such mixing will allow the manufacture to vary such variables, such as strength of scent, texture of the product, appearance of the product, weight, life of the product in the field, etc.

Such varying of the proportions (of carrier materials and/or carrier to animal product) may be done on a trial and error basis by those skilled in the art.

Certain compositions may prove more adverse to wet weather, certain compositions will work better in different humidities and/or elevations. For example the mixture of calcium carbonate and zeolite is found to work very well being resistant to the elements and able to provide a time released odor. Sawdust and potting soil, on the other hand, are not as resistant to the elements and are dissipated rather quickly by precipitation, etc.

Other properties of the compositions may be varied by varying the proportion and type of carrier materials.

1-10. (canceled)

11. An animal repellant composition, consisting essentially of:
one or more granular, dry form carrier materials selected from the group consisting of sand, clay, talc, gypsum, vermiculite and psyllium husks; and
one or more predator animal products mixed with said one or more carrier materials.

12. A composition according to claim 11, said composition being in a dry form, said composition comprising 70-99.7% carrier material by weight and 0.3-30% animal product by weight.

13. A composition according to claim 12, said composition comprising approximately 96% carrier material by weight and 4% animal product by weight.

14. A composition according to claim 11, said composition being in a liquid form, said composition comprising 0.001%-69% carrier material by weight and 31-99.999% animal product by weight.

15. A composition according to claim 16, said composition comprising approximately 15% carrier material by weight and approximately 85% animal product by weight.

16. A composition according to claim 11, said one or more predator animal products being selected from the group consisting of animal urine, animal feces and animal glandular secretions.

17. A method of repelling animals, comprising:
obtaining a composition consisting essentially of: (i) one or more granular, dry form carrier materials selected from the group consisting of sand, clay, talc, gypsum, vermiculite, psyllium husks, and soil, and (ii) one or more predator animal products mixed with said one or more carrier materials; and
spreading said composition over an area from which said animals are desired to be repelled.

18. A method according to claim 30, said one or more predator animal products being selected from the group consisting of animal urine, animal feces and animal glandular secretions.

19. A method according to claim 30, said obtaining step comprising mixing said one or more carrier materials with said one or more predator animal products.

20. An animal attractant composition, consisting essentially of:
one or more granular, dry form carrier materials selected from the group consisting of sand, clay, talc, gypsum, vermiculite and psyllium husks; and
one or more animal products mixed with said one or more carrier materials.

21. A composition according to claim 33, said composition being in a dry form, said composition comprising 70-99.7% carrier material by weight and 0.3-30% animal product by weight.

22. A composition according to claim 34, said composition comprising approximately 96% carrier material by weight and 4% animal product by weight.

23. A composition according to claim 34, said composition being in a liquid form, said composition comprising 0.001%-69% carrier material by weight and 31-99.999% animal product by weight.

24. A composition according to claim 13, said composition comprising approximately 15% carrier material by weight and approximately 85% animal product by weight.

25. A composition according to claim 34, said one or more animal products being selected from the group consisting of animal urine, animal feces and animal glandular secretions.

26. A method of attracting animals, comprising:
obtaining a composition consisting essentially of: (i) one or more granular, dry form carrier materials selected from the group consisting of sand, clay, talc, gypsum, vermiculite, psyllium husks, and soil, and (ii) one or more animal products mixed with said one or more carrier materials; and
spreading said composition over an area to which said animals are desired to be attracted.

27. A method according to claim 39, said one or more animal products being selected from the group consisting of animal urine, animal feces and animal glandular secretions.

28. A method according to claim 40, said obtaining step comprising mixing said one or more carrier materials with said one or more animal products.
